(19) United States
(12) Patent Application Publication
(10) Pub. No.: US 2025/0287970 A1
(43) Pub. Date: Sep. 18, 2025

(54) PROCESSED FAT FOOD, AND MANUFACTURING METHOD OF PROCESSED FAT FOOD

(71) Applicant: AHJIKAN CO.,LTD., Hiroshima (JP)

(72) Inventors: Ryo HIRAO, Hiroshima (JP); Takayuki MURAKAMI, Hiroshima (JP)

(21) Appl. No.: 18/859,983

(22) PCT Filed: Apr. 7, 2023
(86) PCT No.: PCT/JP2023/014444

§ 371 Date: Oct. 24, 2024

(30) Foreign Application Priority Data
Apr. 25, 2022 (JP) 2022-071310

(51) Int. Cl. A23G 1/34; A23G 1/38; A23G 1/48

(52) U.S. Cl. CPC A23G 1/34; A23G 1/38; A23G 1/48

(57) ABSTRACT

The present invention is directed to providing a completely novel processed fat food having a chocolate-like flavor, and a manufacturing method of the processed fat food. The processed fat food of the present invention contains roasted burdock and a cocoa butter alternative. The processed fat food of the present invention preferably contains 7.0-75.0 mass % of the roasted burdock and 25.0-93.0 mass % of the cocoa butter alternative. The manufacturing method of the processed fat food of the present invention includes a roasting step of subjecting a roasting treatment to burdock, and a mixing step of mixing roasted burdock obtained in the roasting step with the cocoa butter alternative.

### RELATED APPLICATIONS

The present application is a National Phase of International Application No. PCT/JP2023/014444 filed Apr. 7, 2023, which claims priority to Japanese Application No. 2022-071310, filed Apr. 25, 2022.

### TECHNICAL FIELD

The present invention relates to a processed fat food and a method for manufacturing the processed fat food.

### BACKGROUND ART

Chocolate, like coffee, wine, and cheese, is a luxury food enjoyed around the world. In many countries, including the EU, chocolate is protected as “food culture” by standardizing a composition and manufacturing method of traditional chocolate. Despite these conservative trends, research and development into new raw materials of chocolate is also proceeding, and a variety of techniques have been proposed.

For example, Patent Document 1 discloses a chocolate containing a powdered fat composition. Herein, the powdered fat composition contains a fat powder having a melting point of 50° C. or higher and a double long-chains β-type crystal. A content of lauric acid in the total amount of constituent fatty acids of the fat contained in the chocolate is 20 to 60 mass %, and a content of the fat powder in the fat contained in the chocolate is 11 to 26 mass %.

Further, Patent Document 2 discloses a method for reducing a slimy and oily feeling experienced after consumption of a chocolate containing 7.0% by weight of vegetable sterol for lowering serum cholesterol. The vegetable sterol and fat, in which unsaturated fatty acids are included in 35% oleic acid, 3.5% linoleic acid, and 0.4% linolenic acid, are added after microparticulation by a refiner and at the latter stage of conching. Thereby, the method reduces a slimy and oily feeling experienced after consumption of a chocolate containing vegetable sterol for lowering serum cholesterol.

### PRIOR ART DOCUMENT

### Patent Document

Patent Document 1: Japanese Patent Publication No. 6957128
Patent Document 2: Japanese Patent Publication No. 6578396

### SUMMARY OF INVENTION

### Technical Problems

Chocolate is a luxury food that has traditionally been produced by using a compressed fat, i.e., cocoa butter (CB), made from cocoa liquor (CL) which is obtained by fermenting, roasting, grinding, etc. cotyledons (nibs) of cacao beans. For that reason, a cacao usage rate in chocolate is standardized and protected in each country (for example, EU Standard 2000/36/EC, Codex Alimentarius 2001, etc.). Japan also has the “Fair Competition Code for the Labeling of Chocolate Products,” and anything that does not meet standards of this code cannot be called chocolate.

Due to the background, many techniques have been reported for improving various qualities and flavors by defining a composition of fats, as described in Patent Documents 1 and 2. However, there has been no technique related to chocolate-like foods that did not use any cacao-derived raw materials (i.e., cocoa liquor, cocoa butter, etc.).

In consideration of the current situation, the present inventors have attempted to create a completely novel processed fat food that allows consumers to experience a chocolate-like flavor without essentially requiring a cacao-derived raw material.

Therefore, an object of the present invention is to provide a completely novel processed fat food having a chocolate-like flavor, and a method for manufacturing the processed fat food.

### Solution to Problems

The above problems can be solved by the following measures.
(1) A processed fat food containing roasted burdock and a cocoa butter alternative.
(2) The processed fat food described in (1), in which a content of the roasted burdock is 7.0 to 75.0 mass %, and a content of the cocoa butter alternative is 25.0 to 93.0 mass %.
(3) The processed fat food according to (1) or (2), in which the cocoa butter alternative is one or more selected from coconut oil, CBE, CBI, CBR, and CBS.
(4) A method for manufacturing a processed fat food, including: a roasting step of subjecting burdock to a roasting treatment; and a mixing step of mixing roasted burdock obtained in the roasting step with a cocoa butter alternative.

### Advantage Effect of Invention

According to the present invention, it is possible to provide a completely novel processed fat food having a chocolate-like flavor, and a method for manufacturing the processed fat food.

### BRIEF DESCRIPTION OF DRAWINGS

FIG. 1A is an image showing an appearance of Sample 6-1.

FIG. 1B is an image showing an appearance of Sample 6-2.

FIG. 1C is an image showing an appearance of Sample 6-3.

FIG. 1D is an image showing an appearance of Sample 6-4.

FIG. 1E is an image showing an appearance of Sample 6-5.

FIG. 1F is an image showing an appearance of Sample 6-6.

FIG. 2 is an image showing an appearance of Sample 3-3.

### DESCRIPTION OF EMBODIMENTS

Hereinafter, embodiments for carrying out a processed fat food and a method for manufacturing the processed fat food according to the present invention will be described.

### Processed Fat Food

A processed fat food of this embodiment contains roasted burdock and a cocoa butter alternative. That is, the processed fat food according to the embodiment uses at least roasted burdock and a cocoa butter alternative as raw materials.

Further, the processed fat food according to the embodiment can also be called a “chocolate-like food” or a “chocolate-flavored food” because the processed fat food has a chocolate-like flavor.

Here, it should be noted that the processed fat food according to the embodiment does not essentially require cocoa-derived raw materials (i.e., raw materials derived from cocoa beans: cocoa liquor, cocoa mass, cocoa butter, cocoa powder, etc.), but does not completely deny inclusion of such raw materials. However, as described in detail below, the processed fat food according to the embodiment exhibits a chocolate-like flavor even though the processed fat food does not contain any cacao-derived raw materials. In addition to the above feature, cacao-derived raw materials have various problems, such as rising prices due to growing global demand, very complicated manufacturing processes, and inducement of caffeine intake.

Therefore, the processed fat food according to the embodiment preferably has a low proportion of cocoa-derived raw materials (for example, more preferably a total content of f cocoa-derived raw materials is 10 mass % or less), and most preferably does not contain any cocoa-derived raw materials.

### Roasted Burdock

Roasted burdock is burdock that has been subjected to a roasting treatment (for example, at 110 to 270° C. for 5 to 55 minutes).

The present inventors have found surprisingly that incorporating roasted burdock and a cocoa butter alternative described below into a processed fat food allows the processed fat food to exhibit a chocolate-like flavor without essentially requiring a cacao-derived raw material. Further, the present inventors have found that a processed fat food containing roasted burdock and a cocoa butter alternative has an excellent smooth mouth feel, snappiness, and palatability. Accordingly, the present inventors have found that the resulting processed fat food is extremely similar to regular chocolate.

Here, burdock used to prepare roasted burdock can be of any origin or variety.

A content of roasted burdock in the processed fat food is preferably 7.0 mass % or more, more preferably 10.0 mass % or more, 20.0 mass % or more, or 23.0 mass % or more.

Further, the content of roasted burdock in the processed fat food is preferably 75.0 mass % or less, more preferably 72.2 mass % or less, 70.0 mass % or less, 68.0 mass % or less, 65.0 mass % s or less, 62.0 mass % or less, 60.0 mass % or less, 50.0 mass % or less, 40.0 mass % or less, or 33.3 mass % or less.

Ensuring that the roasted burdock content is set within the predetermined range allows the chocolate-like flavor of the processed fat food to be more certainly exhibited.

A particle size of the roasted burdock is not particularly limited. For example, when classified into 50 mesh on (i.e., a particle size of 0.3 mm or more), 50 mesh pass and 150 mesh on (i.e., a particle size of 0.1 mm or more and less than 0.3 mm), and 150 mesh pass (i.e., a particle size of less than 0.1 mm), all of them have a chocolate-like flavor, while the 150 mesh pass has the strongest flavor.

Therefore, it is preferable that a particle size of the roasted burdock is smaller (i.e., less than 0.1 mm).

### Cocoa Butter Alternative

A cocoa butter alternative (CBA) is a fat used to replace cocoa butter, and can also be called a “vegetable fat (i.e., a fat derived from plants) excluding cocoa butter. “Examples of a cocoa butter alternative include: coconut oil (refined oil, unrefined oil (virgin oil)), palm oil, illipe butter, kokum butter, shea butter, sunflower oil, rapeseed oil, CBE (Cocoa butter equivalent), CBI (Cocoa butter improver), CBR (Cocoa butter replacer), CBS (Cocoa butter substitute), and other hydrogenated fats. The cocoa butter alternative may be one or more selected from those materials. Among them, at least one or more selected from coconut oil, CBE, CBI, CBR, and CBS is preferred.

As described above, the inventors have discovered that incorporation of a cocoa butter alternative and roasted burdock into a processed fat food enables the processed fat food to exhibit a chocolate-like flavor without essentially requiring a cacao-derived raw material. In addition to the distinguished feature, the inventors have also discovered that the resulting processed fat food is excellent in a smooth mouth feel, snappiness, and palatability.

A content of the cocoa butter alternative in the processed fat food is preferably 25.0 mass % or more, more preferably 28.0 mass % or more, 30.0 mass % or more, 32.0 mass % or more, 35.0 mass % or more, 38.0 mass % or more, 40.0 mass % or more, 45.0 mass % or more, 46.0 mass % or more, or 50.0 mass % or more.

Further, the content of the cocoa butter alternative in the processed fat food is preferably 93.0 mass % or less, more preferably 90.0 mass % or less, 80.0 mass % or less, 70.0 mass % or less, or 66.7 mass % or less.

Ensuring that the content of the cocoa butter alternative falls within the predetermined range allows not only the smooth mouth feel of the processed fat food to be made more favorable but also moldability to be ensured.

### Others

The processed fat food according to this embodiment may contain auxiliary raw materials such as those used in general chocolate, but of course the processed fat food may not contain those raw materials.

Examples of the auxiliary raw materials include sugar (e.g., white sugar, granulated sugar, brown sugar, etc.), milk (e.g., whole milk powder, skim milk powder, etc.), flavorings (e.g., vanilla essence, etc.), emulsifiers (e.g., lecithin, etc.), liquor, dried fruit, nuts (e.g., walnuts, etc.), etc. In addition, when sugar (e.g., particularly granulated sugar) is contained, a content thereof is, for example, 40 mass % or less, 35.0 mass % or less, 32.0 mass % or less. Further, when vanilla essence is contained, a content thereof is, for example, 1.0 mass % or less, 0.5 mass % or less.

Furthermore, addition of an emulsifier to the processed fat food (for example, 0.1 to 0.8 mass %, preferably 0.3 to 0.5 mass %) allows the food to be appropriately molded even if a content of the cocoa butter alternative is reduced (for example, even if it is 38 mass % or less).

### Product Aspects

Here, the processed fat food of this embodiment has a chocolate-like flavor. Thereby, the processed fat food can be made into a block-shaped product (i.e., a chocolate alternative product) similar to regular chocolate products. Further, the processed fat food can also be widely applied to a general chocolate processed product (such as a fresh chocolate-like product mixed with fresh cream, chocolate confectionery combined with biscuits or cookies, or a chocolate drink added to a beverage).

As described above, the processed fat food of this embodiment contains a cocoa butter alternative and roasted burdock. Therefore, the processed fat food not only has a chocolate-like flavor but also is excellent in a melting-in-the-mouth feeling, snappiness, and palatability.

Further, the processed fat food according to the embodiment uses roasted burdock, while it does not essentially require cacao-derived raw materials of which cultivating areas are limited to a tropical zone or the like. Therefore, since the processed fat food of this embodiment can be produced using only raw materials obtained in places relatively close to the consumption area, it is possible to suppress an increase in product prices due to distribution costs. Further, from an environmental perspective, it can also contribute to reducing CO₂ during distribution.

Moreover, the processed fat food according to the embodiment does not essentially require cacao-derived raw materials such as cocoa liquor and cocoa butter which require temperature control for hygienic storage. Due to this feature, it is possible to suppress an increase in product prices caused by management costs of raw materials.

Furthermore, the processed fat food according to the embodiment does not essentially require any cacao-derived raw materials. Thereby, the processed fat food can be a caffeine-free food, making it possible to meet various needs of consumers.

In addition, the processed fat food according to the embodiment contains roasted burdock, allowing consumers to enjoy a various health benefits of burdock (such as improved bowel movements, reduced blood sugar levels, and reduced cholesterol levels).

Further, the processed fat food according to the embodiment does not essentially require cacao-derived raw materials that are produced complicated and long-term processes such as fermentation, drying, roasting, shell removal, and grinding. Therefore, the processed fat food has an advantage of being able to simplify a manufacturing method thereof.

### Method for Manufacturing Processed Fat Food

A method for manufacturing the processed fat food according to the embodiment includes a roasting step and a mixing step (i.e., conching step).

Here, the manufacturing method for the processed fat food according to the embodiment may include a cutting step and a drying step before the roasting step, as appropriate, and may include a tempering step and a molding step after the mixing step. Further, a heat treatment step may be included either before or after the cutting step.

Namely, the method for manufacturing the processed fat food according to the embodiment is carried out in the order of a cutting step→a drying step—a roasting step—a mixing step—a tempering step—a molding step, and may include a heat treatment step either before or after the cutting step. Here, the steps other than the roasting step and the mixing step may be carried out as appropriate.

### <Heat Treatment Step>

A heat treatment Step is a step of heating burdock (i.e., a root of burdock) at 35 to 95° C. for 5 to 180 minutes. As described above, when the heat treatment step is carried out, it may be carried out at least either before or after the cutting step.

This heat step promotes treatment an activity of polysaccharide-degrading enzymes contained in burdock, thereby more increasing an amount of fructose thus produced. Further, the heat treatment step can inactivate a polyphenol oxidase enzyme contained in burdock so as to produce more fructose. This fructose thus produced can then react with Maillard reaction products and polyphenols, etc., to produce a more stable antioxidant. As a result, it is possible to avoid a decrease in a content of the polyphenol. This feature enables the resulting roasted burdock to have a high antioxidant ability.

A heat treatment in the heat treatment step can be performed by steaming, but is not limited thereto. For example, the heat treatment can be performed by roasting, hot water bath, frying, or in a warming cabinet or steamer.

Further, the heat treatment can be arbitrarily set within the range of the above conditions by adjusting a heat treatment temperature and a heat treatment time. For example, when the heat treatment temperature is set at 35° C., the heat treatment time can be set for 180 minutes. Alternatively, when the heat treatment temperature is set at 95° C., the heat treatment time can be set for 5 minutes.

### <Cutting Step>

A cutting step is a step in which burdock is cut into a predetermined shape and size.

A shape and size to be cut in this cutting step are not particularly limited. For example, a root of the burdock can be cut into quarters or eighths with a thickness of about 0.2 to 3 mm, or it can be shredded. In order to make the product into a powder form, it is preferable to pulverize the product into fine particles of about 45 to 500 mesh size using a pulverizer after a drying step described below, from a viewpoint of handling the product.

### <Drying Step>

A drying step is a step in which burdock is dried. A drying treatment is carried out at 30 to 70° C., preferably 40 to 60° C., more preferably 45 to 55° C., until a moisture content of the burdock reaches about 5 to 10%. When a burdock root is dried, the polysaccharide-degrading enzymes contained in the raw burdock root decompose polysaccharides into smaller molecules, thereby producing fructose.

The drying treatment is preferably performed by ventilation drying at the above-mentioned temperature, but is not limited thereto. For example, freeze drying, steam drying, superheated steam drying, reduced pressure drying, sun drying, or the like, which are carried out by controlling temperature conditions within the above-mentioned range, can also be used.

<Roasting Step>A roasting step is s step of roasting burdock. A roasting treatment may be carried out under conditions of 110 to 270° C., preferably 132 to 180° C., more preferably 140 to 165° C., for 5 to 55 minutes, preferably 20 to 45 minutes. The roasting step imparts a roasted aroma to the processed fat food thus produced, thereby enhancing a chocolate-like flavor. Further, the roasting step can more surely inactivate the polyphenol oxidase enzyme contained in burdock, resulting in achievement of higher antioxidant ability.

The roasting step can be arbitrarily set within the above-mentioned ranges by changing a roasting temperature and roasting time. For example, when the roasting temperature is set at 110° C., the roasting time can be set to 45 to 55 minutes. Alternatively, when the roasting temperature is set at 270° C., the roasting time can be set to 5 to 13 minutes.

### <Mixing Step (i.e., Refining Step, Conching Step)>

A mixing step is a step in which roasted burdock obtained in the roasting step is mixed with a cocoa butter alternative. Since the mixing step is a step of distributing the cocoa butter alternative evenly throughout the processed fat food, the mixing step can also be referred to a refining step or a conching step.

Note, refining in a manufacturing method of typical chocolate is a process for reducing a particle size of raw materials (such as sugar). Therefore, in the present invention refining may be performed as needed. Further, conching in a manufacturing method of typical chocolate is carried out under strict conditions (about 70° C., 12 to 24 hours) in order to remove unpleasant odors derived from the raw materials due to over-fermentation. However, the roasted burdock and the cocoa butter alternative used in the present invention do not have such unpleasant odors. Thereby, low temperature conditions (50° C. or lower, for example, 20 to 50° C.) are acceptable, and the raw materials can be uniformly mixed even in a short period of time (within 5 hours, for example, 3 to 5 hours).

Here, the mixing step can be carried out using a general mixer.

### <Tempering Step>

A tempering step is a step of performing temperature adjustment treatment to form a stable crystalline structure of the raw materials (especially fat) in order to afford processed fat foods a glossy appearance and a smooth texture. More specifically, in the tempering step, the raw materials are heated (to a temperature range higher than the melting point of the fat used, for example, 50 to 80° C.) to melt it, cooled (for example, to 27 to 29° C.) while stirring, and then heated again (for example, to 31 to 32° C.) and maintained at that temperature for 5 to 15 minutes.

However, this tempering step is not essential and can be omitted.

### <Molding Step>

A molding step is a step of forming the raw materials into a desired shape.

Here, the molding treatment in the molding step may be any molding treatments that are carried out when producing general chocolate. For example, the molding treatment may be a molding treatment using a mold or a coating treatment for coating an object.

Note, When the tempering step is omitted, the raw materials after the mixing step may be heated to a melting temperature (for example, 40 to 50° C.) and then molded.

### EXAMPLES

Hereinafter, the present invention will be described more specifically with reference to examples.

### Example 1

In Example 1, sensory evaluations of processed fat foods were carried out.

### <<Raw Materials Used in Manufacturing Each Sample>>

Raw materials used in manufacturing each sample are listed in Tables 1 to 5. Here, details of the raw materials shown in Tables 1 to 5 are as follows.

For a “roasted burdock tea powder”, used was “Japanese Domestic Roasted Burdock Powder for Tea Powder” manufactured by Ahjikan Co., Ltd. The roasted burdock was produced via a roasting treatment at about 200° C. for about 20 minutes. The resulting product was used without conducting a classification treatment.

For a “roasted burdock roasted at 200° C.”, used was “Roasted Burdock Tea Gobou No Okage” manufactured by Ahjikan Co., Ltd. The roasted burdock was produced via a roasting treatment at about 200° C. for about 20 minutes. The resulting product was used without conducting a classification treatment.

For a “roasted burdock roasted at 110° C.”, used was “Roasted Burdock Tea (i.e., a low roasted product)” manufactured by Ahjikan Co., Ltd. The roasted burdock was produced via a roasting treatment at about 110° C. for about 30 minutes. The resulting product was used without conducting a classification treatment.

For a “roasted burdock roasted at 270° C.”, used was “Roasted Burdock Tea (i.e., a highly roasted product)” manufactured by Ahjikan Co., Ltd. The roasted burdock was produced via a roasting treatment at about 270° C. for about 15 minutes. The resulting product was used without conducting a classification treatment.

For a “classification treated roasted burdock”, used was “Roasted Burdock Tea Gobou No Okage” manufactured by Ahjikan Co., Ltd. The roasted burdock was produced via a roasting treatment at about 200° C. for about 20 minutes, and was then crushed in a mixer (TM8300, TESMO) for 10 minutes. The resulting product was then classified into three particle sizes, namely “0.3 mm or more,” “0.1 mm or more and less than 0.3 mm,” and “less than 0.1 mm,” by using SANPO stainless steel sieves (aperture 100 μm, aperture 300 μm).

For a “dried burdock”, used was “Raw Material of Roasted Burdock Tea” manufactured by Ahjikan Co., Ltd. The dried burdock was not roasted and was used without a classification treatment after being ground for 10 minutes in a mixer (TM8300, TESMO).

For a “carob powder”, used was “Organic Carob Powder” manufactured by Santa Rosa Co., Ltd.

For a “Hojicha Powder”, used was “Freshly Roasted Hojicha” manufactured by Ohashi Tea Co., Ltd.

For “soybean flour”, used was “Japanese Domestic Soybean Flour” manufactured by Maeda Co., Ltd.

For “instant coffee”, used was “AGF MAXIM (registered trademark)” manufactured by Ajinomoto AGF.

For “chicory coffee”, used was “Chicory Straight Coffee” manufactured by P@life Co., Ltd.

For “dandelion coffee”, used was “Morinokokage Health Tea SD Series” manufactured by P@Life Co., Ltd.

For “Jerusalem artichoke tea”, used was “Roasted Jerusalem Artichoke Tea Bags from Kumamoto Prefecture” manufactured by Sato Tea Ltd.

For a “coconut oil (Virgin)”, used was “Virgin Coconut Oil” manufactured by Taiyo Oil & Fats Co., Ltd.

For a “coconut oil (refined)”, used was “RCO” manufactured by Taiyo Yushi Co., Ltd.

For a “palm oil”, used was “Nissin Delica Premium” manufactured by Nisshin Oillio Group, Ltd.

For “granulated sugar”, w used as “Suzuran Brand Granulated Sugar” manufactured by Nippon Beet Sugar Co., Ltd.

For “vanilla essence”, used was “Vanilla Essence” manufactured by Kyoritsu Foods Co., Ltd.

For “CBE”, used was “Vienta 50C” manufactured by Nisshin Oillio Group, Ltd.

For “CBR”, used was “ISfat” manufactured by Nisshin Oillio Group, Ltd.

For an “emulsifier”, used was “SY-Glyster (registered trademark) CRS-75” manufactured by Sakamoto Pharmaceutical Co., Ltd.

### <<Manufacturing Method of Each Sample>>

### <Samples 1-1 to 1-4, 1-9 to 1-17, 2-1, 2-3, 3-1 to 3-3>

A manufacturing method (i.e., a manufacturing method A) of Samples 1-1 to 1-4, 1-9 to 1-17, 2-1, 2-3, and 3-1 to 3-3 was carried out as follows.

Raw materials listed in the table were subjected to a mixing treatment of being mixed in a bowl with a spatula. Then, after the raw materials were heated to about 40-50° C. to melt, the resulting mixture was poured into a mold with a plurality of depressions (3.7 cm length×2.7 cm width×0.3 cm height). Thereafter, the mixture was stored in a refrigerator (about 5° C.).

### <Samples 1-5 to 1-8>

A manufacturing method of Samples 1-5 to 1-8 was the same as the manufacturing method A, except that the raw materials listed in the table were mixed in a melangeur (PG503, Premier Co., Ltd.) for 5 hours in the mixing treatment.

### <Samples 2-2, 2-4 to 2-7>

A manufacturing method of Samples 2-2, 2-4 to 2-7 was the same as the manufacturing method A, except that a substitute of roasted burdock listed in the table was crushed in a mixer (TM8300, TESMO) for 10 minutes, and then classified using a SANPO stainless steel sieve (aperture 300 μm) (i.e., burdock pieces that passed the sieve were used).

### <Samples 4-1 to 4-3>

A manufacturing method of Samples 4-1 to 4-3 was the same as the manufacturing method A, except that the roasted burdock was ground for 10 minutes in a mixer (TM8300, TESMO) as shown in the table and described above, and then subjected to a predetermined classification treatment.

### <Sample 5-1>

A manufacturing method of Sample 5-1 was the same as the manufacturing method A, except that unroasted burdock listed in the table was ground in a mixer (TM8300, TESCOM) for 10 minutes.

### <<Evaluation Items>>

For each sample thus manufactured using the methods described above, six panelists assigned a score on a three-point scale of 0 point, 1 point, or 2 points for each of the following evaluation items: “flavor,” “smooth mouth feel”, “snappiness,” and “palatability” in accordance with the evaluation criteria below. Then, the six panelists calculated a total score for each sample. Thereafter, a score rate of each sample for each evaluation item (=“total score of each sample”/“maximum score of 12 points”×100) was calculated. Further, in each evaluation item, samples with a score rate of 60% or more were evaluated as “excellent” (i.e., equal to chocolate), samples with a score rate of 30% or more and less than 60% were evaluated as “good” (i.e., similar to chocolate), and samples with a score rate of less than 30% were evaluated as “poor” (i.e., different from chocolate).

Here, in each evaluation, samples stored in a refrigerator at about 5° C. (i.e., samples taken out of the refrigerator within 30 minutes) were used.

### <A: Flavor>

A flavor was evaluated as follows: when “a flavor of a sample was the same as chocolate”, a score thereof was 2 points; when “a flavor of chocolate can be felt in a sample”, a score thereof was 1 point; and when “a flavor of a sample was not that of chocolate”, a score thereof was 0 point.

Note, each flavor was evaluated based on the overall aroma and taste perceived when eating each sample. Herein, the closer the flavor was to regular chocolate, the higher the score was.

### <B: Smooth Mouth Feel>

Smooth mouth feel was evaluated as follows: when “a sample melted equally to chocolate”, a score therefore was 2 points, when “feeling that a sample melted like chocolate”, a score thereof was 1 point, and when “a sample did not melt in the mouth as chocolate” a score thereof was 0 point.

Note, the evaluation of smooth mouth feel was determined based on sensation that a sample was melting felt when eating the sample. Herein, when a sample was melting similarly to regular chocolate, a score thereof was high.

### <C: Snappiness>

Snappiness was evaluated as follows: when “a sample had equal snappiness to chocolate”, a score thereof was 2 points; when “feeling a sample have snappiness like chocolate”, a score thereof was 1 point; and when “a sample had no snappiness of chocolate”, a score thereof was 0 point.

Note, the snappiness was evaluated based on sensation felt when biting into a sample. The score was higher when the sample broke apart with a “crunch” like regular chocolate.

### <D: Palatability>

Palatability was evaluated as follows: when “no bad smell or bitter taste specific to raw materials was felt in a sample,” a score thereof was 2 points; when “a slight bad smell or bitter taste specific to the raw materials was felt in a sample”, a score thereof was 1 point; and when “a strong bad smell or bitter taste specific to the raw materials was felt in a sample,” a score thereof was point.

Here, the palatability was evaluated based on the overall flavors perceived when eating the sample (however, a burnt smell was not taken into consideration in the evaluation). Here, the more the negative flavors specific to the raw materials (i.e., the bad smell specific to the raw materials and the bitter taste specific thereto in the sample) were not perceived, the higher the score of the sample was. In detail, the negative flavors specific to the raw materials in the samples in Table 1 were the bad smell specific to burdock and the bitter taste specific to burdock. The negative flavors specific to the raw materials in the samples in Table 2 were the bad smell specific to each raw material (for example, the bad smell due to carob in the case of Sample 2-1) and the bitter taste specific to each raw material (for example, the bitter taste due to carob in the case of Sample 2-1).

The tables show raw materials of each sample as well as results in each evaluation.

Here, samples shown in Tables 1 and 2 (except for Samples 1-15 to 1-17) were subjected to four evaluation items: A to D. Samples 1-15 to 1-17 shown in Table 1 did not contain roasted burdock or the like and did not have the negative flavor characteristic of the raw materials, so that they were not evaluated in item D, but evaluated in three evaluation items of A to C. Samples shown in Table 3 were subjected to only two evaluation items of A and B. Further, for samples shown in Tables 4 and 5, instead of the above-mentioned evaluation items, a test was conducted in which three panelists verbally confirmed a flavor of each sample.

TABLE 1

| | Raw Materials (mass %) | | | | | | | | | | | | | | |
|---|---|---|---|---|---|---|---|---|---|---|---|---|---|---|---|
| | | | | | | Roasted Burdock | | | | Auxiliary Raw | | Evaluation Items (%) | | | |
| | Coconut Butter Alternative | | | | | Roasted | | | | Materials | | | B | | D |
| Sam- | Coconut | | Coconut | | | Burdock | Burdock | Burdock | Burdock | Granu- | | | Smooth | C | Palat- |
| ple | Oil | Palm | Oil | | | Tea | roasted | roasted | roasted | lated | Vanila | A | mouth | Snappi- | abil- |
| No. | (Virgin) | Oil | (Refine) | CBE | CBR | Powder | at 200° C. | at 110° C. | at 270° C. | Sugar | Essence | Flavor | feel | ness | ity |
| 1-1 | 66.7 | — | — | — | — | 33.3 | — | — | — | — | — | 83 | 100 | 75 | 67 |
| 1-2 | — | 66.7 | — | — | — | 33.3 | — | — | — | — | — | 83 | 92 | 25 | 58 |
| 1-3 | — | — | 66.7 | — | — | 33.3 | — | — | — | — | — | 92 | 100 | 83 | 75 |
| 1-4 | — | — | 66.5 | — | — | 33.3 | — | — | — | — | 0.2 | 92 | 92 | 92 | 83 |
| 1-5 | — | — | 46.0 | — | — | — | 23.0 | — | — | 30.8 | 0.2 | 100 | 100 | 83 | 100 |
| 1-6 | — | — | 46.2 | — | — | — | 23.0 | — | — | 30.8 | — | 92 | 100 | 83 | 100 |
| 1-7 | — | — | 46.2 | — | — | — | — | 23.0 | — | 30.8 | — | 75 | 92 | 83 | 100 |
| 1-8 | — | — | 46.2 | — | — | — | — | — | 23.0 | 30.8 | — | 58 | 92 | 67 | 67 |
| 1-9 | — | — | — | 66.7 | — | 33.3 | — | — | — | — | — | 50 | 83 | 100 | 42 |
| 1-10 | — | — | — | 66.5 | — | 33.3 | — | — | — | — | 0.2 | 67 | 100 | 100 | 67 |
| 1-11 | — | — | — | 46.1 | — | 23.1 | — | — | — | 30.8 | — | 100 | 92 | 100 | 100 |
| 1-12 | — | — | — | — | 66.7 | 33.3 | — | — | — | — | — | 42 | 75 | 83 | 42 |
| 1-13 | — | — | — | — | 66.5 | 33.3 | — | — | — | — | 0.2 | 42 | 83 | 83 | 50 |
| 1-14 | — | — | — | — | 46.1 | 23.1 | — | — | — | 30.8 | — | 92 | 75 | 83 | 100 |
| 1-15 | — | — | 100 | — | — | — | — | — | — | — | — | 0 | 67 | 83 | — |
| 1-16 | — | — | — | 100 | — | — | — | — | — | — | — | 0 | 75 | 75 | — |
| 1-17 | — | — | — | — | 100 | — | — | — | — | — | — | 0 | 50 | 83 | — |

TABLE 2

| | Raw Materials (mass %) | | | | | | | | | | | |
|---|---|---|---|---|---|---|---|---|---|---|---|---|
| | Cocoa | | | | | | | | | | | |
| | Butter | | | | | | | | Evaluation Items (%) | | | |
| | Alternative | Roasted Burdock Replacement | | | | | | | | B | | |
| Sample | Coconut | Carob | Hojicha | Soybean | Instant | Chicory | Dandelion | Jerusalem | A | Smooth | C | D |
| No. | Oil (Virgin) | Powder | Powder | Flour | Coffee | Coffee | Coffee | Artichoke | Flavor | mouth feel | Snappiness | Palatability |
| 2-1 | 66.7 | 33.3 | — | — | — | — | — | — | 17 | 50 | 75 | 25 |
| 2-2 | 66.7 | — | 33.3 | — | — | — | — | — | 0 | 0 | 50 | 25 |
| 2-3 | 66.7 | — | — | 33.3 | — | — | — | — | 0 | 33 | 50 | 33 |
| 2-4 | 66.7 | — | — | — | 33.3 | — | — | — | 8 | 33 | 75 | 8 |
| 2-5 | 66.7 | — | — | — | — | 33.3 | — | — | 25 | 33 | 67 | 17 |
| 2-6 | 66.7 | — | — | — | — | — | 33.3 | — | 25 | 17 | 75 | 33 |
| 2-7 | 66.7 | — | — | — | — | — | — | 33.3 | 17 | 42 | 75 | 50 |

TABLE 3

| | Raw Materials (mass %) | | | | | |
|---|---|---|---|---|---|---|
| | | | Roasted | | | |
| | Coconut Butter | | Burdock | | Evaluation Items (%) | |
| | Alternative | | Roasted | Auxiliary Raw | | B |
| Sample | Coconut | | Burdock Tea | Materials | A | Smooth |
| No. | Oil (Virgin) | CBE | Powder | Emulsifier | Flavor | mouth feel |
| 3-1 | 90.0 | — | 10.0 | — | 58 | 100 |
| 3-2 | 40.0 | — | 60.0 | — | 50 | 25 |
| 3-3 | — | 33.7 | 65.9 | 0.4 | 42 | 50 |

TABLE 4

| | Raw Materials (mass %) | | | |
|---|---|---|---|---|
| | | Roasted Burdock | | |
| | | | Classified | |
| | Coconut Butter | Classified | Roasted | Classified |
| | Altanative | Roasted | Burdock | Roasted |
| Sample | Coconut Oil | Burdock | 0.1 mm ≤ x < | Burdock |
| No. | (Virgin) | 0.3 mm ≤ x | 0.33 mm | x < 0.1 mm |
| 4-1 | 66.7 | 33.3 | — | — |
| 4-2 | 66.7 | — | 33.3 | — |
| 4-3 | 66.7 | — | — | 33.3 |

TABLE 5

Raw Material (mass %)

| Sample | Cocoa Butter Alternative | Unroasted Burdock |
|---|---|---|
| No. | Coconut Oil (Virgin) | Dried Burdock |
| 5-1 | 66.7 | 33.3 |

### <Discussion of Results>

Table 1 shows results of varying a type of cocoa butter alternative, a type of roasted burdock, and s presence or absence of auxiliary raw materials.

According to results of Samples 1-1 to 1-3 in Table 1, it was confirmed that a “flavor” and a “smooth mouth feel” of each sample were equivalent to those of chocolate, regardless of whether coconut oil (virgin), palm oil, or coconut oil (refined) was used as a cocoa butter alternative. Further, it was confirmed that “palatability” thereof was not adversely affected.

Based on these results, it can be inferred that effects of the present invention (i.e., exhibiting a chocolate-like flavor) can be achieved even if various vegetable oils are used as a cocoa butter alternative.

However, since Sample 1-2 using palm oil with a low melting point did not show good snappiness, it was confirmed that if excellent shappiness is also demanded, it is better to use vegetable oil with a relatively high melting point (e.g., coconut oil).

According to results of Samples 1-3 to 1-8 in Table 1, regardless of the type of roasted burdock or the presence or absence of auxiliary raw materials, it was confirmed that the “flavor,” “smooth mouth feel,” and “snappiness” of each sample were equivalent to those of chocolate, and the “palatability” thereof was also excellent.

Based on these results, it was confirmed that the effects of the present invention (i.e., exhibiting a chocolate-like flavor) is not exerted based on the auxiliary raw materials, but is exerted solely by the combination of the “cocoa butter alternative” and “roasted burdock.”

According to results of Samples 1-9 to 1-14 in Table 1, even when CBE or CBR was used as a cocoa butter substitute, it was confirmed that the “flavor”, “smooth mouth feel” and “snappiness” were equivalent to those of chocolate, and the “palatability” was also excellent.

Based on these results, it was confirmed that even when CBE or CBR is used as a cocoa butter alternative, the effects of the present invention (i.e., exhibiting a chocolate-like flavor) can be certainly achieved, just like when coconut oil is used.

According to results of Samples 1-15 to 1-17 in Table 1, if roasted burdock is not contained, a “flavor” of each sample will not be that of chocolate. Therefore, when comparing the results of Samples 1-1 to 1-14 in Table 1 with the results of Samples 1-15 to 17, it was found that “roasted burdock” is essential in the present invention.

Table 2 shows results of using various replacements in place of roasted burdock.

According to results of Samples 2-1 to 2-7 in Table 2, even when various replacements (e.g., roasted green tea powder that has a roasted flavor) were used, the effects of the present invention (i.e., exhibiting a chocolate-like flavor) could not be achieved. In addition, Samples 2-1 to 2-7 did not achieve good results in terms of the “smooth mouth feel” and “palatability.”

Based on these results, it was confirmed that the effects of the present invention are not achieved by simply using roasted raw materials, while the effects are specifically achieved only when roasted “burdock” is used.

Table 3 shows results when contents of the cocoa butter alternative and roasted burdock were changed.

Sample 3-1 in Table 3 shows results of using a significantly less content burdock (i.e., of roasted results of using a significantly more content of cocoa butter alternative). Sample 3-2 shows results of using a significantly more content of roasted burdock (i.e., results of using a significantly less content of cocoa butter alternative). Sample 3-3 shows results of using an even more content of roasted burdock than Sample 3-2 by incorporating an emulsifier (i.e., results of using an even less content of cocoa butter alternative than Sample 3-2). Here, it was confirmed that all of Samples 3-1 to 3-3 had a flavor similar to chocolate.

Based on these results, it was confirmed that the effects of the present invention are exhibited within a relatively wide range of the contents of both raw materials (i.e., cocoa butter alternative and roasted burdock).

Further, as shown in results of Sample 3-2, it was also confirmed that when the content of the cocoa butter alternative was low (below 40.0 mass %), good results were not obtained with respect to the “smooth mouth feel.” However, as shown in results of Sample 3-3, it was also confirmed that, when an emulsifier was added, good results in terms of the “smooth mouth feel” could be obtained even if the content of the cocoa butter alternative was reduced (i.e., even if it was 40.0 mass % or less).

Table 4 shows results of varying a particle size of the roasted burdock thus used.

A flavor evaluation by the three panelists concluded that all of Samples 4-1 to 4-3, which used roasted burdock with particle sizes of “0.3 mm or more,” “0.1 mm or more but less than 0.3 mm,” and “less than 0.1 mm,” had a chocolate-like flavor. In particular, the flavor evaluation concluded that Sample 4-3, which used roasted burdock with a particle size of “less than 0.1 mm,” had the strongest chocolate-like flavor.

Due to these results, it was confirmed that the particle size of the roasted burdock used in the present invention is preferably small (for example, less than 0.1 mm).

Table 5 shows results when unroasted burdock was used instead of roasted burdock.

A flavor evaluation by the three panelists concluded that Sample 5-1, which used unroasted burdock, had no chocolate-like flavor.

Due to these results, it was confirmed that the effect of the present invention (i.e., exhibiting a chocolate-like flavor) is not merely an effect exerted by “burdock” but rather an effect exerted by “roasted burdock”.

As a supplementary test to Example 1, a test was also carried out to confirm effects of the tempering treatment.

Sample 1-3a was prepared by using the same raw materials as Sample 1-3 shown in Table 1 and by carrying out a tempering step.

In detail, a manufacturing method of Sample 1-3a was the same as the manufacturing method A, except that after the mixing step, raw materials were melted at 60° C., cooled to 27° C. while stirring, and then heated to 31° C. and maintained at that state for about 5 minutes, resulting in a tempering step.

When the panelists checked this Sample 1-3a, they concluded that, although Sample 1-3a had a glossier finish than Sample 1-3, there was no significant difference in a flavor or smooth mouth feel. That is, it was confirmed that in the present invention, the tempering step is not an essential step and can be omitted.

### Example

In Example 2, “moldability” of processed fat foods was evaluated.

### <Materials Used for Producing Each Sample>

Materials thus used for producing each sample are listed in Table 6. Details of the raw materials shown in Table 6 are as follows.

For a “roasted burdock tea powder”, used was “Japanese Domestic Produced Roasted Burdock Powder for Tea” manufactured by Ahjikan Co., Ltd. The roasted burdock was produced by roasting at about 200° C. for about 20 was used without being classified. For “Coconut Oil (Virgin)”, used was “Virgin Coconut Oil” manufactured by Taiyo Oil & Fats Co., Ltd.

### <<Manufacturing Methods of Each Sample>>

Samples 6-1 to 6-6 were manufactured in the same manner as the manufacturing method A of Example 1, except that a mold with a plurality of depressions (3.0 cm length×3.0 cm width×1.5 cm height) was used.

The table shows raw materials for each sample.

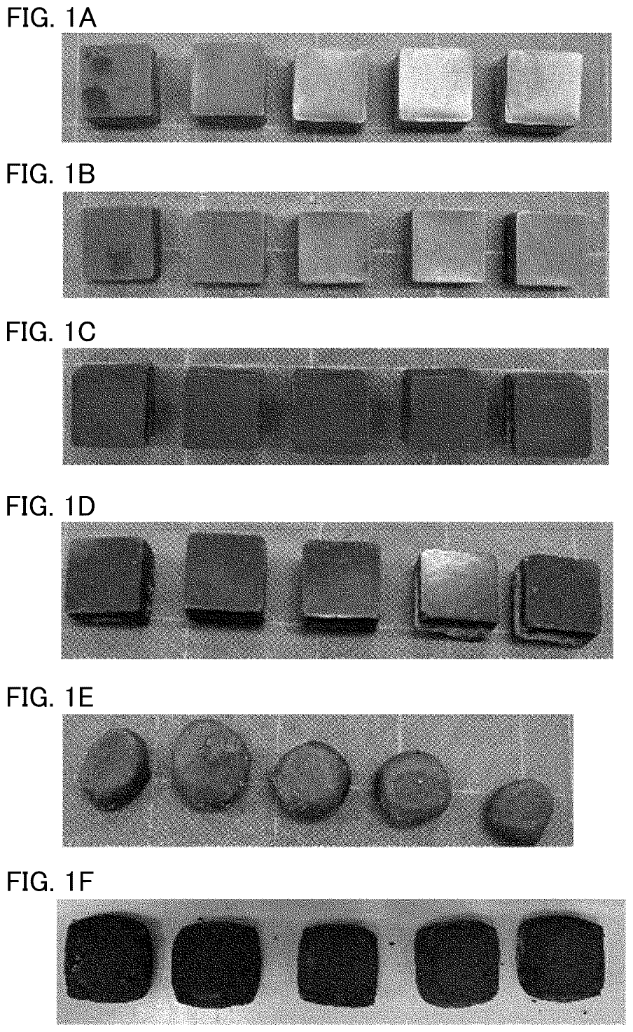

Further, FIG. 1 shows images (i.e., images taken with a camera) of an appearance of each sample. FIG. 1A shows an appearance of Sample 6-1. FIG. 1B shows an appearance of Sample 6-2. FIG. 1C shows an appearance of Sample 6-3. FIG. 1D shows an appearance of Sample 6-4. FIG. 1E shows an appearance of Sample 6-5. FIG. 1F shows an appearance of Sample 6-6.

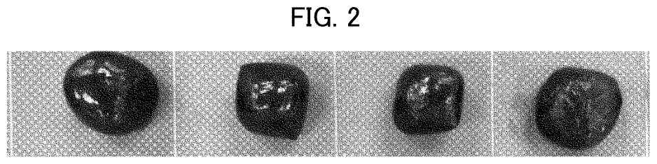

Here, an image (taken by a camera) of an appearance of Sample 3-3 shown in Table 3 is also shown in FIG. 2.

TABLE 6

Raw Material (mass %)

| | | Roasted Burdock |
|---|---|---|
| Sample | Coconut Butter Alternative | Roasted Burdock |
| No. | Coconut Oil (Virgin) | Tea Powder |
| 6-1 | 90.0 | 10.0 |
| 6-2 | 80.0 | 20.0 |
| 6-3 | 70.0 | 30.0 |
| 6-4 | 50.0 | 50.0 |
| 6-5 | 40.0 | 60.0 |
| 6-6 | 38.0 | 62.0 |

### <<Discussion of Results>>

From images in FIGS. 1A to 1F, it was confirmed that molding was possible within a wide range of contents of roasted burdock, more specifically, from 10.0 mass % (i.e., a content of cocoa butter alternative: 90.0 mass %) to 62.0 mass % (i.e., a content of cocoa butter alternative: 38.0 mass %).

Further, it was also confirmed that when a content of roasted burdock was high (i.e., 60 mass % or more), as in Samples 6-5 and 6-6, appearances thereof after molding were slightly deteriorated.

However, based on an image in FIG. 2, it was also confirmed that, when an emulsifier was added, the product could be molded even if a content of roasted burdock was high (i.e., 60 mass % or more), in other words, even if a content of the cocoa butter alternative was low (i.e., 40.0 mass % or less).

### Example 3

In Example 3, aroma components of various processed fat foods were examined.

### <<Measurement Targets of Aroma Components>>

Results of measurement targets of aroma components are shown in Table 7.

Note, for the “high cacao (commercially available)” shown in Table 7, used was “Chocolate Effect Cacao 95%” manufactured by Meiji Co., Ltd.

### <<Conditions of Gas Chromatography >>

Aroma components of each of the above-mentioned raw materials were detected by gas chromatography (Trace1310 GC/ISQ QD MS/TriPlus ThermoFisher Scientific Co., Ltd.). Detailed detection RSH, conditions are as follows:
Column: ThermoFisher Scientific TG-WAXMS (60 m×0.25 mm)
Mobile phase: Helium gas, 200 kPa, constant pressure mode
Injection temperature: 250° C.
Column temperature: 40° C. for 4 minutes, then 250° C. for 9 minutes (heating rate 5° C./min)
Detector: Mass spectrometer, EI method, 70 eV
Detector temperature: 200° C.

TABLE 7

| | | High Cocao | | | | | | | | |
|---|---|---|---|---|---|---|---|---|---|---|
| Detection | | (Comertially | Sample No. | | | | | | | Flavor |
| Time (DT) | Flavor Component | Available) | 1-6 | 1-5 | 2-1 | 2-2 | 2-3 | 2-5 | 2-6 | Expression |
| ↓ | 2-methyl-propanal | Good | Good | Good | Poor | Poor | Poor | Poor | Poor | Chocolate |
| | 2-methyl-butanal | Good | Good | Good | Poor | Good | Poor | Poor | Good | Aromar |
| | 3-methyl-butanal | Good | Good | Good | Good | Good | Poor | Poor | Poor | |
| | 2,5-dimethyl-pyrazine | Good | Good | Good | Good | Poor | Good | Poor | Good | Cocoa |
| | 2,3-dimethyl-pyrazine | Good | Good | Good | Poor | Poor | Poor | Poor | Poor | Aroma |
| | 2-ethyl-5-methyl-pyrazine | Good | Good | Good | Poor | Poor | Poor | Poor | Poor | Nut Aroma |
| | trimethyl-pyrazine | Good | Good | Good | Poor | Poor | Poor | Poor | Poor | Cocoa |
| | | | | | | | | | | Aroma |
| | tetramethyl-pyrazine | Good | Poor | Poor | Poor | Poor | Poor | Poor | Poor | Roasted, |
| | | | | | | | | | | Nut Aroma |
| | 2-furanmethanol | Good | Good | Good | Poor | Good | Good | Good | Good | Sweet |
| | | | | | | | | | | Scent |
| | Vanillin | Good | Poor | Good | Poor | Poor | Poor | Poor | Poor | Vanilla |
| | | | | | | | | | | Aroma |

| | | | | | | | | |
|---|---|---|---|---|---|---|---|---|
| the number of flavor components needed for | 10 (full marks) | 8 | 9 | 2 | 3 | 2 | 1 | 3 |
| chocolate | | | | | | | | |

### <<Discussion of Results>>

As is clear when determining results in Table 7, it was confirmed that a composition of aromatic components was quite similar between commercially available high-cocoa chocolate and the processed fat foods of the present invention (i.e., Samples 1-5 and 1-6).

This result is consistent with the evaluations in Example 1 (particularly the evaluation of “A flavor”). Thus, the result is considered to support the results of Example 1.

As described above, the processed fat food and the method for manufacturing the processed fat food according to the present invention have been described in detail through the embodiments and examples for carrying out the invention. However, the gist of the present invention is not limited to those descriptions and must be interpreted broadly based on the claims. Further, a person skilled in the art can devise various modifications based on the claims, specification, and drawings of this application, and such modifications are also included in the technical scope of the present invention.

1. A processed fat food containing roasted burdock and a cocoa butter alternative.

2. The processed fat food according to claim 1, wherein a content of the roasted burdock is 7.0 to 75.0 mass %, and a content of the cocoa butter alternative is 25.0 to 93.0 mass %.

3. The processed fat food according to claim 1, wherein the cocoa butter alternative is one or more selected from coconut oil, CBE, CBI, CBR, and CBS.

4. A method for manufacturing a processed fat food, comprising:
a roasting step of subjecting burdock to a roasting treatment; and
a mixing step of mixing roasted burdock obtained in the roasting step with a cocoa butter alternative.

5. The processed fat food according to claim 2, wherein the cocoa butter alternative is one or more selected from coconut oil, CBE, CBI, CBR, and CBS.
